(19) United States
(12) Patent Application Publication
(10) Pub. No.: US 2026/0329527 A1
(43) Pub. Date: Oct. 22, 2026

(54) VOICE INPUT DEVICE AND VOICE INPUT METHOD

(71) Applicant: Sharp Kabushiki Kaisha, Sakai City (JP)

(72) Inventor: Kengo TSURUZONO, Tokyo (JP)

(21) Appl. No.: 19/699,686

(22) Filed: Jun. 5, 2026

Related U.S. Application Data
(63) Continuation of application No. PCT/JP2023/046999, filed on Dec. 27, 2023.

(51) Int. Cl. G06F 3/16; G06F 3/01; G06F 3/0482; G10L 15/08

(52) U.S. Cl. CPC G06F 3/167; G06F 3/013; G06F 3/0482; G10L 15/08; G10L 2015/088

(57) ABSTRACT

A voice input device includes a keyword recognizer and an extractor. The recognizes a keyword from an input voice. The extractor extracts an option from an option list belonging to a user interface (UI) element of an input target, based on the keyword recognized.

### BACKGROUND OF THE INVENTION

### Field of the Invention

The present invention relates to a voice input device and a voice input method.

### Description of Related Art

When a voice is input to an information processing device such as a personal computer (PC) or a mobile terminal device, it is necessary to switch a mode to a mode for performing a voice input process in advance. For example, it is necessary to click a microphone icon or the like arranged in a text field to perform a voice input to a text input field. Moreover, it is necessary to speak a specific phrase in advance to perform a voice input to a voice assistant. Moreover, Patent Document 1 discloses a technique for recognizing voice commands and controlling a mobile terminal device based on the recognized commands.

### Patent Documents

[Patent Document 1] Japanese Unexamined Patent Application, First Publication No. 2009-252238

### SUMMARY OF THE INVENTION

As described above, when a voice input is performed, it is necessary to switch a mode to a voice input mode in advance. This is intended to prevent an erroneous operation caused by conversations not intended for a voice input or by surrounding environmental sounds. However, a process for performing a mode switching operation every time voice input is performed is a troublesome task for the user.

In view of the above-described problems, an objective of the present invention is to provide a voice input device and a voice input method for enabling voice input operations to be easily performed without setting a voice input mode.

According to an aspect of the present invention, there is provided a voice input device including: a keyword recognizer configured to recognize a keyword from an input voice; and an extractor configured to extract an option from an option list belonging to a user interface (UI) element of an input target, based on an extracted keyword.

According to an aspect of the present invention, there is provided a voice input method including steps of: recognizing a keyword from an input voice; and extracting an option from an option list belonging to a UI element of an input target, based on an extracted keyword.

According to the present invention, by operating a specific target UI element, a user can perform a voice input operation without setting a voice input mode.

### BRIEF DESCRIPTION OF THE DRAWINGS

FIG. 1 is a block diagram showing a configuration of an information processing device to which a voice input device according to an embodiment of the present invention can be applied.

FIG. 2 is an explanatory diagram of a voice input operation according to a first embodiment of the present invention.

FIG. 3 is an explanatory diagram of a voice input operation according to the first embodiment of the present invention.

FIG. 4 is an explanatory diagram of a voice input operation according to the first embodiment of the present invention.

FIG. 5 is an explanatory diagram of a voice input operation according to the first embodiment of the present invention.

FIG. 6 is a flowchart showing a process of the voice input operation according to the first embodiment of the present invention.

FIG. 7 is a flowchart showing another example of the process of the voice input operation according to the first embodiment of the present invention.

FIG. 8 is an explanatory diagram of a voice input operation according to a second embodiment of the present invention.

FIG. 9 is an explanatory diagram of a voice input operation according to the second embodiment of the present invention.

FIG. 10 is an explanatory diagram of a voice input operation according to the second embodiment of the present invention.

FIG. 11 is an explanatory diagram of a voice input operation according to the second embodiment of the present invention.

FIG. 12 is an explanatory diagram of a voice input operation according to the second embodiment of the present invention.

FIG. 13 is an explanatory diagram of a voice input operation according to the second embodiment of the present invention.

FIG. 14 is an explanatory diagram of a voice input operation according to the second embodiment of the present invention.

FIG. 15 is a flowchart showing a process of the voice input operation according to the second embodiment of the present invention.

FIG. 16 is a flowchart showing another example of the process of the voice input operation according to the second embodiment of the present invention.

FIG. 17 is an explanatory diagram of a voice input operation according to a third embodiment of the present invention.

FIG. 18 is an explanatory diagram of a voice input operation according to the third embodiment of the present invention.

FIG. 19 is an explanatory diagram of a voice input operation according to the third embodiment of the present invention.

FIG. 20 is an explanatory diagram of a voice input operation according to the third embodiment of the present invention.

FIG. 21 is an explanatory diagram of a voice input operation according to the third embodiment of the present invention.

FIG. 22 is an explanatory diagram of a voice input operation according to a fourth embodiment of the present invention.

FIG. 23 is an explanatory diagram of a voice input operation according to the fourth embodiment of the present invention.

FIG. 24 is an explanatory diagram of a modification example of the present invention.

FIG. 25 is a block diagram based on functions of a voice input device according to another aspect of the present invention.

### DETAILED DESCRIPTION OF THE INVENTION

Hereinafter, embodiments of the present invention will be described with reference to the drawings.

### First Embodiment

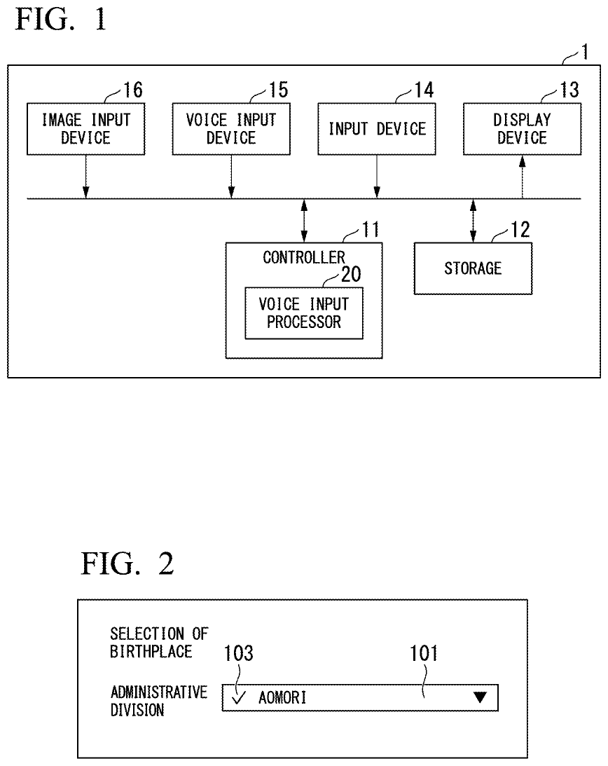

FIG. 1 is a block diagram showing a configuration of an information processing device 1 to which a voice input device according to an embodiment of the present invention can be applied. As illustrated in FIG. 1, the information processing device 1 includes a controller 11, a storage 12, a display device 13, an input device 14, a voice input device 15, and an image input device 16.

The controller 11 includes a central processing unit (CPU) and executes various types of processes in accordance with programs stored in the storage 12. In the present embodiment, the controller 11 implements a voice input processor 20 configured to execute a process based on voice input results from the voice input device 15. More specifically, when a process for executing a specific user interface (UI) element is performed, the controller 11 turns on a voice input operation. Also, the controller 11 recognizes a keyword from an input voice and extracts an option from an option list belonging to the UI element of an input target, based on the keyword that has been extracted. Thus, a desired option can be selected from the option list through a voice input operation without performing a mode setting operation. The controller 11 has a function of a keyword recognizer configured to recognize a keyword from the input voice.

A UI element is an element constituting a user interface and may be any one of a button, a scroll bar, a menu, a checkbox, and the like. Moreover, the UI element may also be a context menu. In the present embodiment, a case where the UI element is a pop-up window, a list box, a pull-down menu, or the like will be described as an example.

The storage 12 includes a storage medium such as a hard disk drive (HDD), a flash memory, an electrically erasable programmable read-only memory (EEPROM), a random-access memory (RAM), or a read-only memory (ROM), or any combination of these storage media.

The storage 12 stores, for example, option lists.

The display device 13 includes a liquid crystal display (LCD), an organic electroluminescence (EL) display, or the like, and displays various types of information on a screen.

The input device 14 includes a keyboard, a mouse, a touch panel, and the like, and accepts various types of input operations.

The voice input device 15 includes a microphone and inputs external sounds as voice signals. The image input device 16 includes a camera and inputs surrounding images.

As described above, in the information processing device 1 according to the first embodiment of the present invention, when a process for executing a specific UI element is performed, a voice input operation is turned on, and options from an option list belonging to the UI element of the input target can be selected by the voice input operation. This will be described below.

In addition, in the following description, a pop-up process indicates that a display element appears to pop up to the foreground. A pop-up display includes a pop-up window and a pop-up menu. The pop-up window is a window that pops up according to a predetermined operation such as a mouse click. The pop-up menu is a UI element in which an option list is displayed in a pop-up manner in the pop-up window and an input for an option in the pop-up menu is accepted. Here, the pop-up menu is regarded as an aspect of the pop-up window.

A focus indicates an element that is in a state in which an input from a user is accepted among UI elements.

Control corresponds to a part that constitutes a UI. In this example, a pop-up menu or a list box corresponds to the control.

A cursor indicates an operation target for selecting an option within control.

A mouse pointer is a mark that moves in response to the movement of a pointing device such as a mouse.

In a voice input operation according to the first embodiment of the present invention, when a pop-up menu is displayed as a specific UI element, a voice input is turned on.

FIGS. 2 to 5 are explanatory diagrams of a voice input operation according to the first embodiment of the present invention. In FIG. 2, a pop-up menu 101 is displayed as a UI element for a user to select a birthplace. In the state shown in FIG. 2, the pop-up menu 101 is in a closed state. In this state, the voice input operation is turned off, and there is no response to a voice input operation from the voice input device 15. That is, even if the user utters a voice in the state shown in FIG. 2, the voice input does not respond. Moreover, in the state shown in FIG. 2, a check mark 103 is attached to “Aomori,” and “Aomori” is selected as the birthplace.

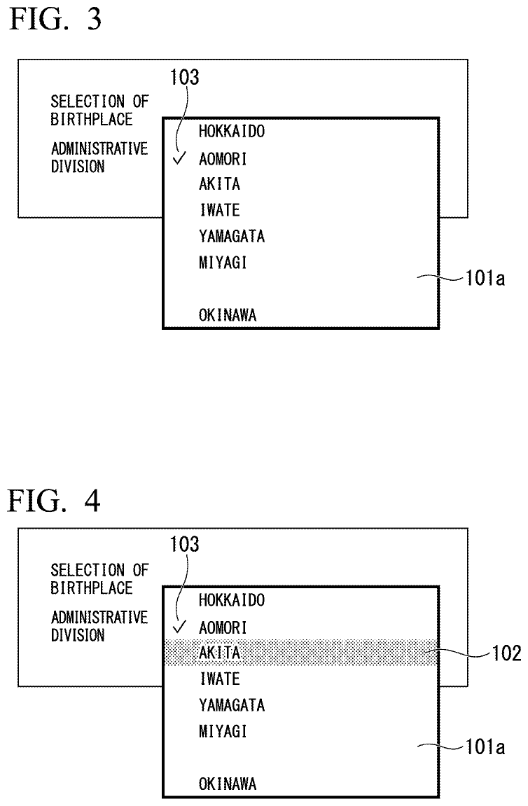

As shown in FIG. 3, if the user clicks the pop-up menu 101 with a mouse, a pop-up menu 101a is displayed in a pop-up manner. In the pop-up menu 101a, options such as “Hokkaido,” “Aomori,” “Akita,” . . . “Okinawa,” and the like are displayed. When the pop-up menu 101a is displayed in a pop-up manner as described above, the voice input operation is turned on. Here, if the user utters a voice included in the options and performs a voice input operation, an option corresponding to the voice input is selected from among the options included in the pop-up menu 101a.

For example, here, it is assumed that the user utters the voice “Akita.” In this case, as shown in FIG. 4, an option belonging to the pop-up menu 101 is extracted using “Akita” as a keyword, and “Akita” is selected as the birthplace. Also, a cursor 102 is moved to the selected option. In addition, even if the user utters a voice that is not included in the pop-up menu 101a, such as “Japan,” the voice input does not respond thereto.

As described above, in the present embodiment, the user's voice input operation is accepted according to only the option within the pop-up menu 101a only while the pop-up menu 101a is displayed in a pop-up manner. According to the present embodiment, because a voice input operation can be performed by displaying the pop-up menu 101a in the pop-up manner, it is not necessary for the user to perform a mode switching operation.

That is, the controller 11 accepts a voice input only for keywords included in the options within the pop-up menu. Thereby, a configuration in which it is possible to prevent the speech from being accepted even if speech other than the keywords included in the options within the pop-up menu is uttered and speech other than the keywords included in the options is not accepted even if speech is uttered in the surroundings and the voice is input from the voice input device 15 and recognized can be adopted.

As operations when a voice input is performed while the pop-up menu 101a is displayed in the pop-up manner, the following two methods can be considered.
(A1) A selection item changes.
(A2) A selected item does not change, a cursor is placed on an option, and the selection item is changed by an operation such as pressing an enter key.

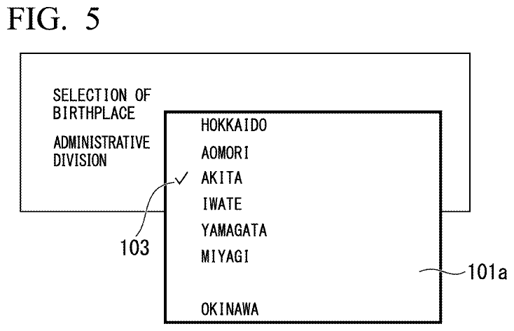

In the method (A1), for example, when the user utters the voice “Akita,” the position of the check mark 103 is changed from “Aomori” to “Akita,” and the option “Akita” is confirmed as shown in FIG. 5. In the method (A2), for example, when the user utters the voice “Akita,” the cursor 102 is placed on the option “Akita,” and the check mark 103 is not changed as shown in FIG. 4. In this method, when the user finally performs an operation such as pressing the enter key, the option “Akita” is confirmed.

Although the method (A1) enables a voice input operation to be performed easily, it is difficult to correct a voice input operation when an erroneous input occurs. In the method (A2), when there is an erroneous input, the voice input operation can be easily restarted, but an operation for confirming the option is required. Either method may be used as the voice input method while the pop-up menu 101a is displayed in the pop-up manner. Moreover, the method (A1) and the method (A2) may be selectable as options.

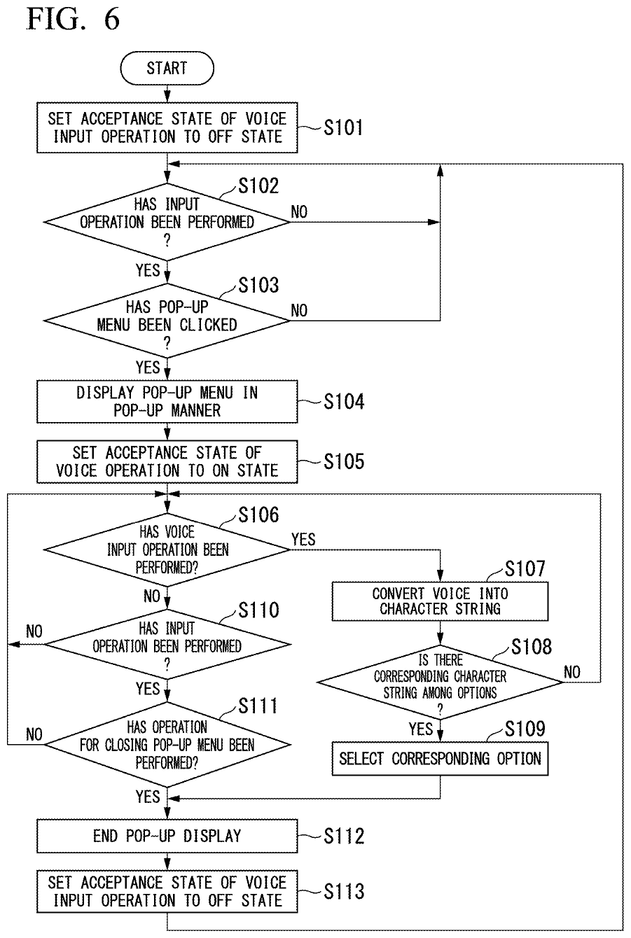

FIG. 6 is a flowchart showing a process of a voice input operation according to the first embodiment of the present invention.
(step S101) The controller 11 sets a voice input acceptance state to an off state in an initial state.
(Step S102) The controller 11 determines whether or not an input operation has been performed from the input device 14. If an input operation has not been performed (step S102: No), the controller 11 returns the process to step S102. If an input operation has been performed (step S102: Yes), the controller 11 moves the process to step S103.
(Step S103) The controller 11 determines whether or not an executed input operation is an operation for clicking the pop-up menu. If the operation for clicking the pop-up menu has not been performed (step S103: No), the controller 11 returns the process to step S102. If the operation for clicking the pop-up menu has been performed (step S103: Yes), the controller 11 moves the process to step S104.
(Step S104) When the pop-up menu has been clicked in step S102, the controller 11 displays the pop-up menu in a pop-up manner and moves the process to step S105.
(Step S105) The controller 11 sets the voice input acceptance state to an on state and moves the process to step S106.
(Step S106) The controller 11 determines whether or not a voice input operation has been performed from the voice input device 15. If a voice input operation has been performed (step S106: Yes), the controller 11 moves the process to step S107. If a voice input operation has not been performed (step S106: No), the controller 11 moves the process to step S110.
(Step S107) If a voice input operation has been performed from the voice input device 15 (step S106: Yes), the controller 11 performs voice recognition on the input voice, converts the voice into a character string, and moves the process to step S108.
(Step S108) The controller 11 compares the character strings of options serving as keywords in the pop-up menu with the character string input by voice, and determines whether or not there is a character string associated with a voice-input character string among the character strings of the options serving as the keywords in the pop-up menu. If there is a character string associated with a voice-input character string among the character strings of the options serving as the keywords in the pop-up menu (step S108: Yes), the controller 11 moves the process to step S109. If there is no associated character string (step S108: No), the controller 11 returns the process to step S106.
(Step S109) The controller 11 selects, as the option, the option having the character string associated with the voice-input character string in the pop-up menu, and moves the process to step S111.
(Step S110) If a voice input operation has not been performed in step S106 (step S106: No), the controller 11 determines whether or not an input operation has been performed from the input device 14. If an input operation has not been performed (step S110: No), the controller 11 returns the process to step S106. If an input operation has been performed (step S110: Yes), the controller 11 moves the process to step S111.
(Step S111) The controller 11 determines whether or not an operation for closing the pop-up menu has been performed. If an operation for closing the pop-up menu has not been performed (step S111: No), the controller 11 returns the process to step S106. If an operation for closing the pop-up menu has been performed (step S111: Yes), the controller 11 moves the process to step S112.
(Step S112) The controller 11 ends the display of the pop-up menu and moves the process to step S113.
(Step S113) The controller 11 sets the voice input acceptance state to the off state and returns the process to step S102.

In addition, in the present embodiment, a voice input is turned off in a state in which the pop-up menu is not displayed. Therefore, even if the user utters a voice while the pop-up menu is closed, a voice input is not performed. Accordingly, to notify the user that voice input cannot be performed in a state in which the pop-up menu 101 is closed, when there is a voice input while the pop-up menu is closed, a warning indicating that an “input based on the keyword is not accepted” may be displayed on the display device 13.

Moreover, even if there is a voice input from the user after the pop-up menu is displayed in the pop-up manner, there may be cases where a voice that is not included in the keywords of the options is input, or the voice cannot be recognized. Accordingly, even if there is a voice input while the pop-up menu is displayed in the pop-up manner, when a voice that is not included in the keywords of the options or an unidentifiable voice is input, a warning indicating that an “input based on the keyword is not accepted” may be displayed on the display device 13.

FIG. 7 is another example of a flowchart showing a voice input operation according to the first embodiment of the present invention. In FIG. 7, processing steps identical to those in FIG. 6 are denoted by the same reference signs, and description thereof is omitted.

In this example, in step S150, the controller 11 determines whether or not a voice input operation has been performed while the pop-up menu is not displayed. When a voice input operation has been performed (step S150: Yes), the controller 11 displays a warning indicating that voice input is not accepted (step S151). As a result, it is possible to notify the user that voice input is not accepted while the pop-up menu is not displayed in a pop-up manner.

Moreover, in this example, when the controller 11 determines that the input voice is not included in the options in step S108 (step S108: No), the controller 11 displays a warning indicating that the voice cannot be identified. Thereby, even if there is a voice input while the pop-up menu is displayed in the pop-up manner, when the input voice is not included in the options or cannot be recognized, it is possible to notify the user that the voice cannot be identified.

### Second Embodiment

Next, a voice input according to a second embodiment of the present invention will be described. In a voice input operation according to the second embodiment of the present invention, when a list box is in focus as a specific UI element, the voice input is turned on.

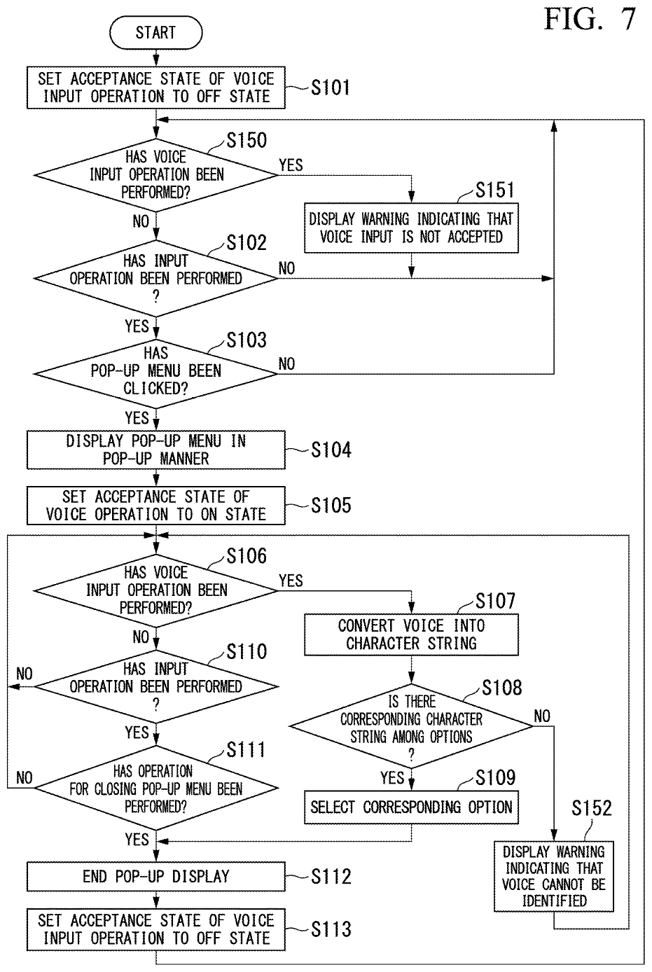

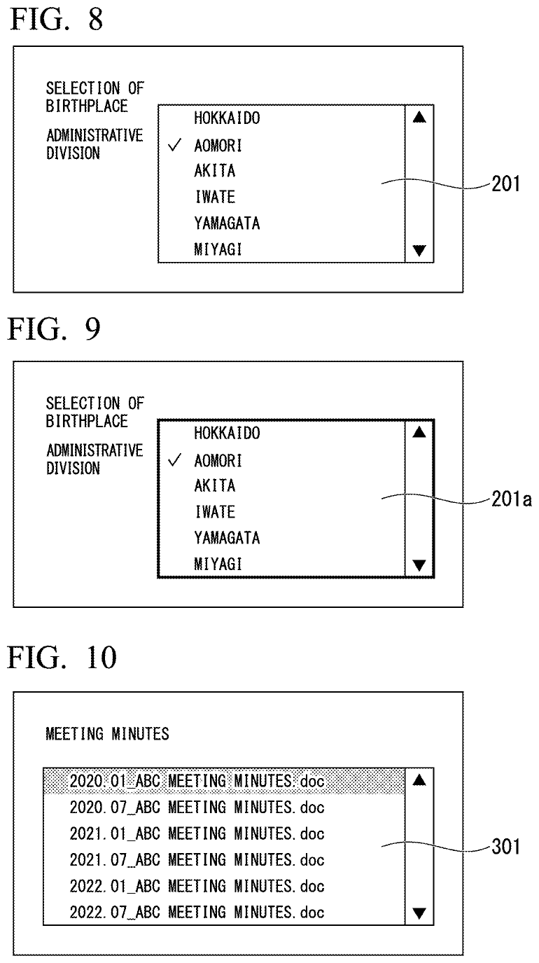

FIGS. 8 and 9 are explanatory diagrams of a voice input operation according to the second embodiment of the present invention.

In FIG. 8, a list box 201 is displayed as a UI element for allowing a user to select a birthplace. In the list box 201, options such as “Hokkaido,” “Aomori,” “Akita,” and the like are displayed. In the state shown in FIG. 8, the list box 201 is not in focus. In such a state, the voice input operation is turned off, and no response is made for a voice from the voice input device 15.

When the user clicks the list box 201 with a mouse, the list box 201 is in focus (indicated by a thick line) as shown in FIG. 9. In a list box 201a in focus, the voice input operation is turned on. That is, when the user performs a voice input operation by uttering a voice corresponding to an option included in the list box 201a in a state in which the list box 201a is in focus, an option corresponding to the voice input is selected from among the options included in the list box 201a.

As described above, in the present embodiment, only options within the list box 201a in focus are configured to accept the user's voice input operation. According to the present embodiment, if the user clicks the list box 201 and performs an operation for putting the list box 201 in focus, a voice input operation can be performed, thereby eliminating the need for the user to perform a mode switching operation.

As methods for displaying an option selected within the list box, the following methods can be considered.
(B1) A display is performed by moving a cursor to an option that satisfies a condition.
(B2) A display is performed by coloring an option that satisfies a condition.

For example, when a document file is searched for in a list box that displays a document list or a file list, there may be a case where document files are to be extracted using “year,” “month,” or the like as conditions. A list box 301 shown in FIG. 10 displays document files as options. Here, when document files are selected using “2021” as a condition from among the options in the list box 301, the list box 301 is in focus and a voice input is performed by uttering “2021” in the present embodiment.

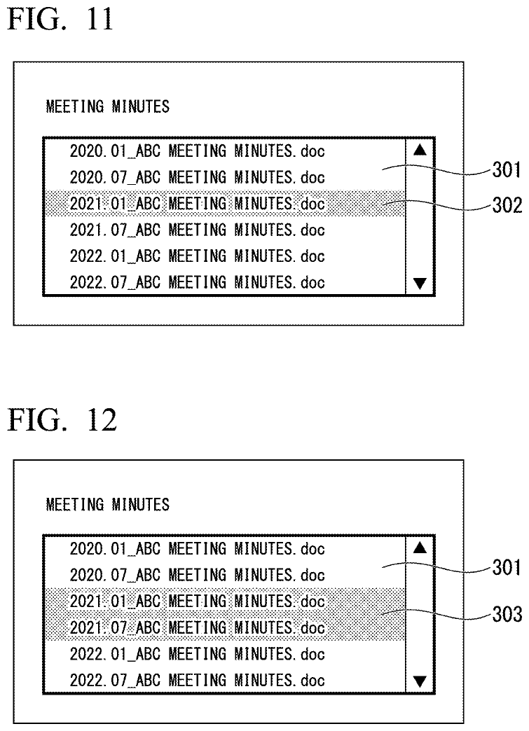

FIGS. 11 and 12 show selection results. In FIG. 11, as indicated by the method (B1), a cursor 302 is moved to the first item of document files having a date that matches the voice input. The document files arranged subsequent to the cursor 302 are the document files of “2021,” which are selection targets.

In FIG. 12, as indicated by the method (B2), document files matching the search target are displayed in a color 303. That is, in FIG. 12, the document files marked with the color 303 are the document files of “2021,” which are selection targets.

Moreover, to prevent an erroneous operation in the voice input for a list box, it is conceivable to provide additional conditions in addition to the application of the focus.

That is, if the focus is on, the focus often remains for a long period of time. Although the focus is on, a UI element on which the focus remains for a long period of time without any user operation is highly likely not to be an operation target of the user. Moreover, there is a possibility that the user is operating a UI element other than the UI element in focus. For example, in the recent years, in the OS of the PC, scrolling using a mouse wheel is often possible when a mouse is positioned for a UI element that is not in focus. When a scrolling operation is performed with a mouse wheel on a UI element that is not in focus, it can be considered that the user is operating the UI element at the position of the mouse pointer instead of the UI element that is in focus. Therefore, it is conceivable to add the following conditions.
(C1) A condition that the mouse pointer is inside or near the UI element is added as a condition under which a voice input is permitted, or this condition is prioritized over the presence or absence of a cursor.
(C2) A condition that the user's line of sight is inside or near the UI element is added as a condition under which a voice input is permitted or this condition is prioritized over the presence or absence of a cursor. In addition, the user's line of sight can be acquired by capturing the user's face with the image input device 16.
(C3) When no voice-based operation is performed for a predetermined time or longer with respect to a UI element on which the cursor is placed, a voice input is ignored until the next operation.

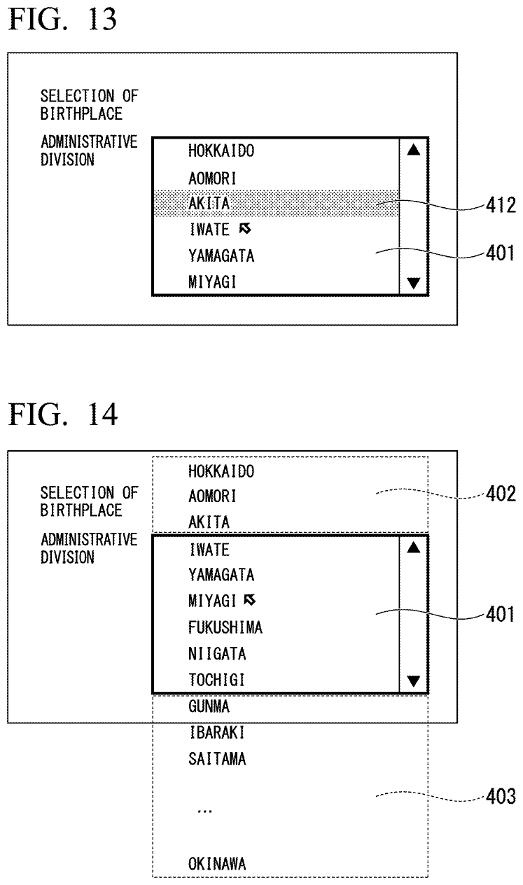

Moreover, in selection using a list box, there may be options that are not displayed within the list box. For example, in FIG. 13, the options displayed in the list box 401 range from “Hokkaido” to “Miyagi,” but the options that can be selected in the list box 401 are originally from “Hokkaido” to “Okinawa.” Options other than those displayed in the list box 401 are located in regions 402 and 403 outside the display region, as shown in FIG. 14.

As the number of options in the list box increases, the number of options located in the regions 402 and 403 outside the list box 401 increases. When the voice input is performed, if options located in the regions 402 and 403 outside the list box 401 are included, the number of erroneous operations due to surrounding voices increases. Moreover, it is difficult for the user to select options that are not displayed in the list box 401. Therefore, in the voice input for the list box, it can be considered to cause a voice input to respond in the following cases.
(D1) The voice input responds only to options that are currently displayed on the screen as a list box.
(D2) The voice input responds to all options included in the list box.
(D3) For each UI element, an attribute indicating whether a voice input responds to all options or only to displayed options is provided.

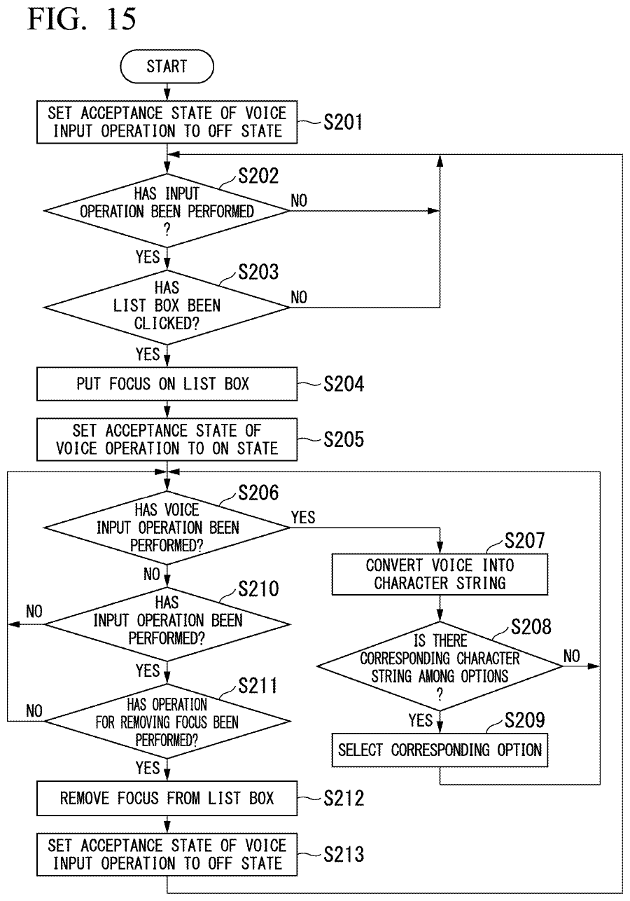

FIG. 15 is a flowchart showing a process in a voice input operation according to the second embodiment of the present invention.
(Step S201) In an initial state, the controller 11 sets a voice input acceptance state to an off state.
(Step S202) The controller 11 determines whether or not an input operation has been performed from the input device 14. If no input operation has been performed (step S202: No), the controller 11 returns the process to step S201. If an input operation has been performed (step S202: Yes), the controller 11 moves the process to step S203.
(Step S203) The controller 11 determines whether or not the executed input operation is an operation for clicking a list box. If an operation for clicking a list box has not been performed (step S203: No), the controller 11 returns the process to step S202. If an operation for clicking a list box has been performed (step S203: Yes), the controller 11 moves the process to step S204.
(Step S204) When the list box is clicked in step S203 (step S204: Yes), the controller 11 displays the list box in focus and moves the process to step S205.
(Step S205) The controller 11 sets the voice input acceptance state to the on state, and moves the process to step S206.
(Step S206) The controller 11 determines whether or not a voice input operation has been performed from the voice input device 15. If a voice input operation has been performed (step S206: Yes), the controller 11 moves the process to step S207. If a voice input operation has not been performed (step S206: No), the controller 11 moves the process to step S210.
(Step S207) When a voice input operation has been performed from the voice input device 15 (step S206: Yes), the controller 11 performs voice recognition on the input voice, converts the voice into a character string, and moves the process to step S208.
(Step S208) The controller 11 compares character strings of options serving as keywords in the list box with a character string obtained by the voice input, and determines whether or not a character string corresponding to the character string obtained by the voice input is present in character strings of options serving as keywords in the list box. When the character string corresponding to the character string obtained by the voice input is present in the character strings of the options serving as the keywords in the list box (step S208: Yes), the controller 11 moves the process to step S209. When no corresponding character string is present (step S208: No), the controller 11 returns the process to step S206. Here, the controller 11 may be configured to accept a voice input only for a keyword associated with an option present in the list box as a keyword recognized from the input voice. Thereby, character strings other than options included in the list box are not accepted as a voice input, and only the options can be accepted with respect to character strings obtained by voice recognition. Accordingly, even if speech is uttered for items other than the options, a voice input can be prevented from being accepted. Here, the controller 11 may be configured to accept a voice input only for a keyword included in a list in which a pop-up menu has popped up, or may be configured to accept voice inputs only for options displayed on the screen within the list that has popped up.
(Step S209) The controller 11 selects, as the option, a character string in the list box corresponding to the character string input by voice, and returns the process to step S206.
(Step S210) If no voice input operation has been performed in step S207 (step S206: No), the controller 11 determines whether or not an input operation has been performed from the input device 14. If an input operation has not been performed (step S210: No), the controller 11 returns the process to step S206. If an input operation has been performed (step S210: Yes), the controller 11 moves the process to step S211.
(Step S211) The controller 11 determines whether or not an operation for removing the focus from the list box has been performed. If the operation for removing the focus from the list box has not been performed (step S211: No), the controller 11 returns the process to step S206. If the operation for removing the focus from the list box has been performed (step S211: Yes), the controller 11 moves the process to step S212.
(Step S212) The controller 11 removes the focus from the list box and moves the process to step S213.
(Step S213) The controller 11 sets the voice input acceptance state to the off state, and returns the process to step S202.

In addition, in the present embodiment, a voice input is turned off in a state in which the list menu is not in focus. Therefore, even if the user utters a voice in a state in which the list menu is not in focus, a voice input is not performed. Accordingly, to notify the user that the voice input cannot be performed in a state in which the list menu is not in focus, if there is a voice input in a state in which the list menu is not in focus, a warning indicating that an “input based on a keyword is not accepted” may be displayed on the display device 13.

Moreover, even if a voice input is accepted from the user in a state in which the list menu is in focus, there may be cases where a voice that is not included in keywords serving as the options is input or a voice cannot be recognized. Accordingly, even if there is a voice input in a state in which the list menu is in focus, when the voice is not included as a keyword or cannot be recognized, a warning indicating that an “input based on a keyword is not accepted” may be displayed on the display device 13.

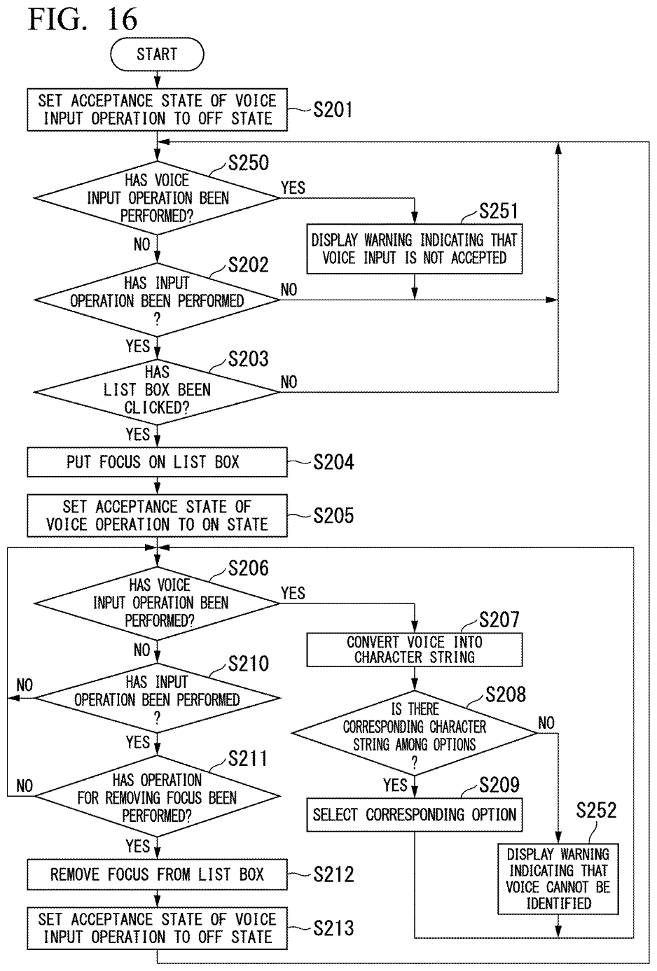

FIG. 16 is another example of a flowchart showing a voice input operation according to the first embodiment of the present invention. In FIG. 16, processing steps identical to those in FIG. 15 are denoted by the same reference signs and descriptions thereof will be omitted.

In this example, in step S250, the controller 11 determines whether or not a voice input operation has been performed in a state in which the list menu is not in focus. When a voice input operation has been performed (step S250: Yes), the controller 11 performs a warning display indicating that a voice input is not accepted (step S251). Thereby, it is possible to notify the user that the voice input is not accepted in a state in which the list menu is not in focus.

Moreover, in this example, when the controller 11 determines that the voice input is not included in the options in step S208 (step S208: No), a warning display indicating that the voice cannot be identified is performed (step S252). Thereby, even if the voice input is performed in a state in which the list menu is in focus, when the input voice is not included in the options serving as keywords or cannot be recognized, it is possible to notify the user that the voice cannot be identified.

### Third Embodiment

Although an option is selected by comparing a character string input by voice with a character string included as an option in the above-described embodiments, it is conceivable to extend the character string to be compared and selected to attribute information added to the option.

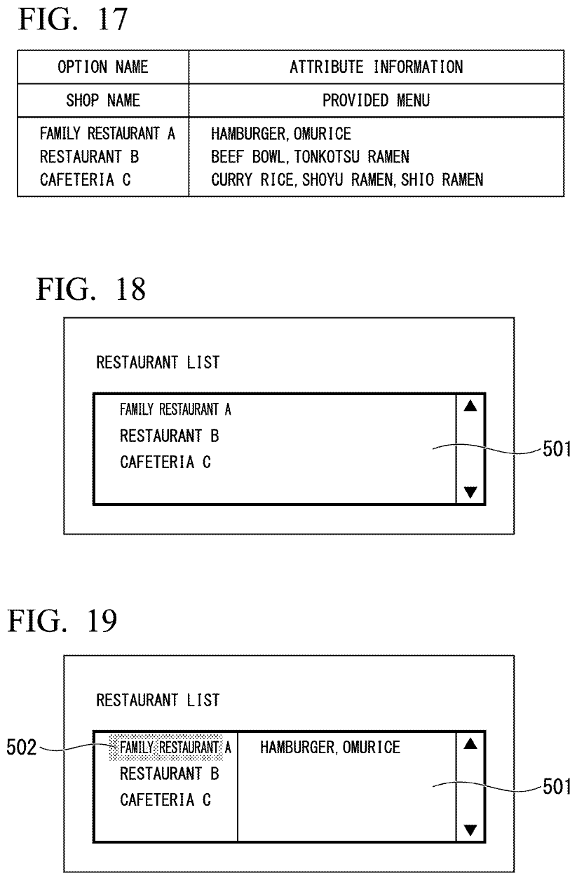

FIGS. 17 to 21 are explanatory diagrams of a voice input operation according to the third embodiment of the present invention. FIG. 17 shows an example of a relationship between character strings serving as options and attribute information added to the options.

In FIG. 17, restaurant names serve as options, and provided menus are added as attribute information. In this example, for an option “Family Restaurant A,” “Hamburger” and “Omurice” are added as the attribute information. An option list is data in which options and attribute information are associated with each other in this way, and may be stored in the storage 12. In this case, if character strings of voice recognition targets are not only the options but also the attribute information added to the options, it becomes responsive not only to a voice input of the character string “Family Restaurant A,” which is included as an option in the list, but also to a voice input of a provided menu serving as attribute information, such as “Hamburger” and “Omurice.”

For example, it is assumed that, from information about restaurant names and provided menus as shown in FIG. 17, a list box 501 in which restaurant names serve as options is generated as shown in FIG. 18. When there is a voice input while the focus is on, the list box 501 responds to the voice input. That is, in the list box 501 as shown in FIG. 18, when a voice input such as “Family Restaurant A” is performed while the focus is on, the option “Family Restaurant A” is selected as shown in FIG. 19, and a cursor 502 is displayed at the option “Family Restaurant A.” Also, the controller 11 reads attribute information corresponding to “Family Restaurant A” from the storage 12 and displays the attribute information within the list, whereby a menu that can be provided at “Family Restaurant A” is displayed on the right side of the restaurant name.

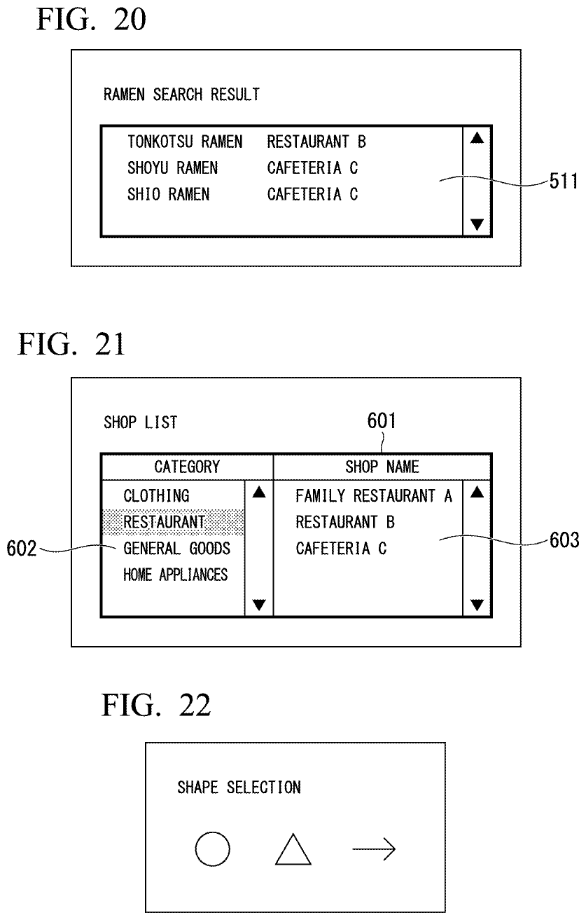

Moreover, the list box 501 responds to attribute information added to options. For example, in the list box 501, when a voice input of attribute information such as “Ramen” is performed while the focus is on, the controller 11 responds to the voice information and displays attribute information including “Ramen” as a keyword and restaurant names corresponding to the attribute information in a list box 511 as shown in FIG. 20. Thereby, the controller 11 can display the list box 511 for selecting names of restaurants that can provide “ramen” as a menu and the ramen provided at those restaurants.

When a voice input for such hierarchical information is performed, information indicating what type of selection can be performed may be presented to the user. For example, a message such as “Please input by voice a restaurant name or a menu you would like to eat” may be displayed on the display screen.

Moreover, the hierarchy may be further multileveled. For example, a hierarchy indicating ramen flavors may be provided below the “Ramen” hierarchy, and data indicating flavors may be used as attribute information, such as displaying a hierarchy indicating flavors such as “miso,” “soy sauce,” and “salt.” In this case, the storage 12 may be configured to store data in which options are associated with attribute information divided into a plurality of hierarchies.

Here, as the number of options to be displayed increases, the possibility of erroneous operations increases. Therefore, for hierarchical information, it is conceivable to limit responses to information below a selected item.

For example, as shown in FIG. 21, it is assumed that there is a list box 601 for selecting shop information. In this list box 601, there is information about a category hierarchy 602 of shops of “clothing,” “restaurant,” “general goods,” and the like and there is information about shop names belonging to each category in a lower hierarchy 603.

In the present embodiment, before an option in the category hierarchy 602 is selected, a voice input responds to include a shop name in the lower hierarchy 603. In this case, information about all shop names is included, and thus the number of options becomes very large.

When a category in the category hierarchy 602 is selected, a voice input responds only to a shop name in the lower hierarchy 603 under the selected category. For example, when “restaurant” is selected from the category hierarchy 602, a voice input responds only to shop names such as “Family Restaurant A,” “Family Restaurant B,” and “Cafeteria C” under the restaurant hierarchy.

As described above, if a keyword associated with an option as a keyword recognized from an input voice is extracted, the controller 11 may be configured to accept, as the next voice input, only a keyword corresponding to a character string included in attribute information belonging to a lower level of the extracted keyword. Also, the controller 11 extracts the keyword accepted by the voice recognition process as an option. Thereby, by storing hierarchical attribute information associated with options, it is possible to extract, from among keywords included in lower-level attribute information belonging to a keyword selected as an option, a keyword obtained by voice recognition. Attribute information of a lower level belonging to a keyword may be extracted from keywords included in attribute information of a level immediately below the keyword, or keywords included in attribute information in any level belonging to the keyword may be extracted.

### Fourth Embodiment

Although options are selected by comparing character strings input by voice with character strings included as options in the above-described embodiments, options included in pop-up menus or list boxes are not limited to character strings. In some cases, options are displayed as icons or illustrations.

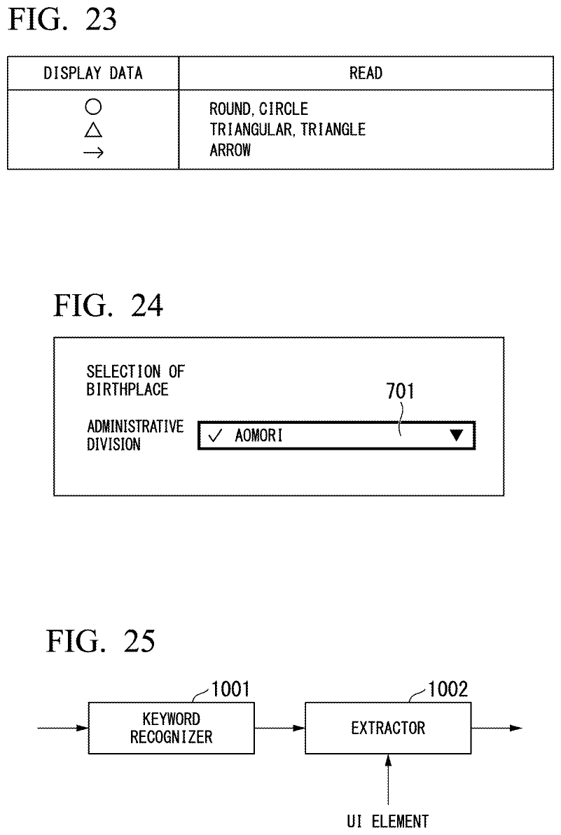

FIGS. 22 and 23 are explanatory diagrams of a voice input operation according to the fourth embodiment of the present invention. For example, as shown in FIG. 22, shapes such as circles and triangles may be included in a pop-up menu or a list box. In this case, as shown in FIG. 23, a character string indicating the reading of each shape may be added as attribute information in correspondence with each shape and stored in the storage 12 as reference data. In this case, for example, the circular shape responds to a voice input such as “round.”

The controller 11 performs voice recognition from the input voice, and extracts, from character strings obtained as a result of the voice recognition, a keyword that matches a character string that is attribute information, based on reference data stored in the storage 12. Also, the controller 11 may be configured to accept a voice input only for the extracted keyword, and to extract an option (for example, a shape or the like) corresponding to the extracted keyword with reference to the reference data stored in the storage 12.

The selectable shapes may be meaningful shapes such as icons or photographs. For example, in a restaurant menu, a ramen icon may be associated with the character string “Ramen,” and, if the user utters a sound of “Ramen,” the ramen icon may be displayed and the ramen may be selected.

Moreover, for example, in a menu for selecting clothing, clothing items may be associated with photographs thereof, and, if the user utters a sound of “checkered sweater,” a photograph of a checkered sweater clothing item may be displayed and the clothing item may be selected. Further, the association is not limited to icons or photographs, and a logo may be associated with a character string.

### Modification Examples and Application Examples

Although the embodiments of the present invention have been described in detail with reference to the drawings, specific configurations are not limited to these embodiments. Moreover, these embodiments may be combined with each other.

For example, in the above-described first embodiment, in the case of a pop-up menu, the voice input is accepted only for the options within the pop-up menu only while the pop-up menu is popping up. Moreover, in the second embodiment, in the case of a list box, the voice input is accepted only for the options within the list box only while the list box is in focus. These may be combined so that, in the case of a pop-up menu, a voice input is accepted only for the options in the pop-up menu only while the pop-up menu is in focus. In this manner, the controller 11 may be configured to accept a voice input only for keywords included in the list box.

That is, as shown in FIG. 24, when a pop-up menu 701 is in focus, voice input operations by the user may be accepted so that options within the pop-up menu 701 can be selected. In this manner, the controller 11 may be configured to accept a voice input only for keywords included in the pop-up menu that has popped up.

FIG. 25 is a block diagram based on functions of a voice input device according to another aspect of the present invention.

As shown in FIG. 25, according to the other aspect of the present invention, the voice input device includes a keyword recognizer 1001 configured to recognize a keyword from an input voice and an extractor 1002 configured to extract an option from an option list belonging to a UI element of an input target, based on the extracted keyword.

All or a part of the voice input device in the above-described embodiment may be implemented by a computer. Moreover, a program for implementing these functions is recorded on a computer-readable recording medium, and the program recorded on the recording medium may be read into a computer system and executed. In addition, the “computer system” used here is assumed to include an operating system (OS) or hardware such as peripheral devices. Moreover, the “computer-readable recording medium” refers to a flexible disk, a magneto-optical disc, a ROM, a portable medium such as a compact disc-ROM (CD-ROM), or a storage device such as a hard disk embedded in the computer system. Furthermore, the “computer-readable recording medium” is assumed to include a medium that holds a program for a certain period of time, such as a volatile memory inside a computer system serving as a server or a client. Moreover, the above-described program may be a program for implementing some of the above-described functions. Further, the above-described function may be implemented in combination with a program already recorded on the computer system or may be implemented using a programmable logic device such as a field programmable gate array (FPGA).

Although embodiments of the present invention have been described in detail above with reference to the drawings, specific configurations are not limited to the embodiments and other designs and the like may also be included without departing from the scope and spirit of the present invention.

### EXPLANATION OF REFERENCES

11 Controller
12 Storage
13 Display device
15 Voice input device
16 Image input device
20 Voice input processor
1001 Keyword recognizer
1002 Extractor

What is claimed is:

1. A voice input device comprising:
a keyword recognizer configured to recognize a keyword from an input voice; and
an extractor configured to extract an option from an option list belonging to a user interface (UI) element of an input target, based on the keyword as recognized.

2. The voice input device according to claim 1,
wherein the UI element comprises a pop-up window, and
wherein the extractor is configured to extract an option from an option list belonging to the pop-up window that has popped up.

3. The voice input device according to claim 1,
wherein the UI element comprises a list box, and
wherein the extractor is configured to extract an option from an option list belonging to the list box.

4. The voice input device according to claim 1,
wherein the UI element of the input target comprises a UI element in focus, and
wherein the extractor is configured to extract an option from an option list belonging to the UI element in focus.

5. The voice input device according to claim 1, further comprising:
a UI element detector configured to detect, among UI elements within a range displayed on a display screen, a UI element of the input target based on an input operation,
wherein the extractor is configured to extract an option from an option list belonging to the UI element detected by the UI element detector.

6. The voice input device according to claim 5, wherein the UI element detector is configured to detect a UI element near a position of a mouse pointer as the UI element of the input target.

7. The voice input device according to claim 5, further comprising:
a line-of-sight detector configured to detect a user's line of sight,
wherein the UI element detector is configured to detect a UI element at about a destination of the user's line of sight detected as the UI element of the input target.

8. The voice input device according to claim 5, wherein the UI element detector is configured to detect the UI element of the input target from among UI elements within a display range of a display screen as scrolled.

9. The voice input device according to claim 1,
wherein the option list includes options and a respective one of attribute information associated with each of the options, and
wherein the extractor is configured to extract an option or attribute information, based on the keyword, from among the options or the attribute information included in the option list.

10. The voice input device according to claim 9, further comprising:
a first display controller configured to cause a display screen to display the attribute information extracted and the option corresponding to the attribute information extracted together when the attribute information is extracted.

11. The voice input device according to claim 1,
wherein the option list includes options which are associated with subordinate option lists which are different in hierarchy level from the options included in the option list, and
wherein the extractor is configured to extract, based on the keyword, an option from the subordinate option lists belonging to an option extracted from the option list.

12. The voice input device according to claim 1, further comprising:
a reference data storage that stores reference data including a shape as the option and a character string associated with the shape,
wherein the extractor is configured to refer to the reference data storage and to extract, as the option, a shape associated with the character string of the keyword.

13. The voice input device according to claim 1, further comprising:
a second display controller configured to display, on a display screen, the option as extracted in a different display mode from options that are unextracted.

14. The voice input device according to claim 2,
wherein the keyword recognizer is configured to accept a voice input for the keyword recognized from the input voice, only if the keyword as recognized is associated with any option included in a pop-up menu of the pop-up window, and
wherein the extractor is configured to extract the option associated with the keyword as accepted by the keyword recognizer.

15. The voice input device according to claim 2,
wherein the keyword recognizer is configured to accept a voice input for the keyword recognized from the input voice, only if the keyword as recognized is included in a pop-up menu of the pop-up window as popped up, and
wherein the extractor is configured to extract an option associated with the keyword recognized by the keyword recognizer.

16. The voice input device according to claim 2,
wherein the keyword recognizer is configured to accept a voice input for the keyword recognized from the input voice only if the keyword as recognized is included in a list box of the pop-up window, and
wherein the extractor is configured to extract an option associated with the keyword recognized by the keyword recognizer.

17. The voice input device according to claim 12,
wherein the keyword recognizer is configured to accept a voice input for the keyword recognized from the input voice only if the keyword corresponds to a character string stored in the reference data storage, and
wherein the extractor is configured to extract, as the option, a shape associated with the character string corresponding to the keyword recognized by the keyword recognizer.

18. The voice input device according to claim 1, further comprising:
a storage that stores data of options and attribute information associated with each other, wherein the attribute information has a plurality of hierarchy levels,
wherein the keyword recognizer is configured to accept a next voice input for a keyword which corresponds to a character string included in an attribute information belonging to a lower hierarchy level of the keyword extracted in case that there is extracted the keyword which has been recognized from the input voice and which are associated with the option, and
wherein the extractor is configured to extract, as the option, the keyword recognized by the keyword recognizer.

19. The voice input device according to claim 1, further comprising:
a message display device configured to display a message indicating that an input based on the keyword is unacceptable, if the keyword is recognized in a case that, among the UI element, there is absent any UI element that can be input.

20. A voice input method comprising:
recognizing a keyword from an input voice; and
extracting an option from an option list belonging to a UI element of an input target, based on the keyword recognized.
